(19) United States
(12) Patent Application Publication
(10) Pub. No.: US 2006/0083194 A1
(43) Pub. Date: Apr. 20, 2006

(54) System and method rendering audio/image data on remote devices

(76) Inventors: Ardian Dhrimaj, Morrisville, NC (US); Scott L. Vance, Cary, NC (US); Martin Trively, Cary, NC (US); Yojak Vasa, Cary, NC (US)

Correspondence Address: MYERS BIGEL SIBLEY & SAJOVEC, P.A., P.O. BOX 37428, RALEIGH, NC, 27627, US

(21) Appl. No.: 10/968,771

(22) Filed: Oct. 19, 2004

(51) Int. Cl. H04Q 7/00

(52) U.S. Cl. 370/328; 370/338

(57) ABSTRACT

The present invention discloses a system and method for rendering multimedia data received by a wireless communications device via a wireless communications network over one or more external multimedia rendering devices. In one embodiment, the present invention receives multimedia data that includes image and audio data from one or more remote parties over the network. A controller in the wireless communications device distinguishes between the received image and audio data. Rather than display the received data on the device display, the controller controls a short-range transceiver to redirect the image data to an external display device for display. Likewise, the controller also controls the short-range transceiver to transmit the received audio data to an external audio device for rendering as audible sound over a speaker. The short-range transceiver transmits the image and audio data to their respective external multimedia rendering devices via one or more short-range interfaces.

### BACKGROUND

The present invention relates generally to wireless communications devices, and particularly to wireless communications devices that render multimedia data to remote multimedia systems.

The ability to participate in a teleconference is useful to the public. It permits multiple parties usually separated by some geographic distance to meet and discuss various issues. Inevitably, this saves both time and money, as parties do not have to traverse potentially great distances in order to meet personally. Rather, they can simply sit in a room equipped with teleconferencing apparatus and participate in the teleconference with one or more parties that may be geographically located anywhere on earth. Large display screens typically associated with these systems make it easy for the parties to view each other, while speaker systems facilitate excellent sound. However, while being able to hear and see well, current teleconferencing systems are also fixed, large and expensive. Thus, their use is often limited to specific common areas such as an office building, for example, which makes teleconferencing difficult or impossible for business people who often travel.

However, wireless communications devices and their associated communications networks typically permit users to engage in teleconferences. For example, most devices come equipped with camera assemblies and functionality that allow users to engage in teleconferencing calls without having to be physically located proximate fixed teleconferencing systems. In these situations, one or more users can view the remote parties on the device's display and hear the associated audio over the device's speaker. The audio and image signals are typically exchanged between parties as packets over a wireless communications network. The ability to participate in a teleconference using one's own wireless communications device is useful, but it does present some problems. One such problem relates to the size and resolution of the display on the user's wireless communications device. Particularly, because the displays are small, they cannot equal the sharpness and visibility provided by larger, more expensive displays. Another related issue is the quality of sound that emanates from the speaker on the communications device. Manufacturers could provide larger displays having better resolution and better speakers on their respective wireless communications devices, but the increased costs naturally associated with such an approach would only be passed to consumers. Moreover, large high-resolution displays represent a serious drain on the wireless device's limited power source.

Therefore, a wireless communications device that could stream multimedia data, such as image/video and/or audio data, to systems having high-resolution displays and high-quality sound would be beneficial.

### SUMMARY

The present invention provides a system and method for rendering multimedia data received by a wireless communications device via a wireless communications network using one or more nearby external rendering devices. The multimedia data may include, for example, images, video, and audio data. Particularly, the wireless communications device comprises a controller, a long-range transceiver to communicate with one or more remote parties over the wireless communications network, and a short-range transceiver. The controller may establish one or more short-range interfaces between the short-range transceiver and the one or more external rendering devices. Multimedia data received via the wireless communications network is transmitted via the one or more short-range interfaces to the one or more external rendering devices, where the image and audio data components are displayed and rendered as audible sound.

In one embodiment, the wireless communications device is engaged in an on-going teleconference call with one or more remote parties. The controller distinguishes between the image/video data and the audio data received from the remote parties over the network, and sends the image/video data to an external display device. The external display device includes a corresponding short-range transceiver to receive the image/video data, and image processing circuitry to render the image/video data on a display. Likewise, the controller also sends the audio data to an external audio device. The external audio device comprises a corresponding short-range transceiver to receive the audio data and audio processing circuitry to render the received audio data as audible sound over a speaker.

The one or more short-range interfaces between the wireless communications device and the external systems may be, for example, ad-hoc networks, or may be hardwired cables that connect the wireless communications device to the external devices. In an alternate embodiment, for example, an external device comprises a computing device having a display and one or more speakers. The wireless communications device transmits the multimedia data including images/video and audio data over the interconnecting cable. The computing device then displays the image/video data on the display, and renders the audio data as audible sound to the user over the one or more speakers.

Additionally, the wireless communications device may download multimedia data created using an application executing on the computing device, and store it in memory. The multimedia data may include audio and image/video data. Once stored, the wireless communications device may establish one or more short-range interfaces to transmit the audio and multimedia data to the one or more external devices. The external devices, as stated above, would display the image/video data on a display, and render the audio data over one or more speakers.

### BRIEF DESCRIPTION OF THE DRAWINGS

FIG. 1 illustrates a wireless communications device according to one embodiment of the present invention.

FIG. 2 illustrates how the wireless communications device might interact with an external display device and external audio device according to one embodiment of the present invention.

FIG. 3 is a flow chart illustrating a method according to one embodiment of the present invention.

FIG. 4 is a perspective view of an alternate embodiment of the present invention.

FIG. 5 is a flow chart illustrating a method according to an alternate embodiment of the present invention.

### DETAILED DESCRIPTION

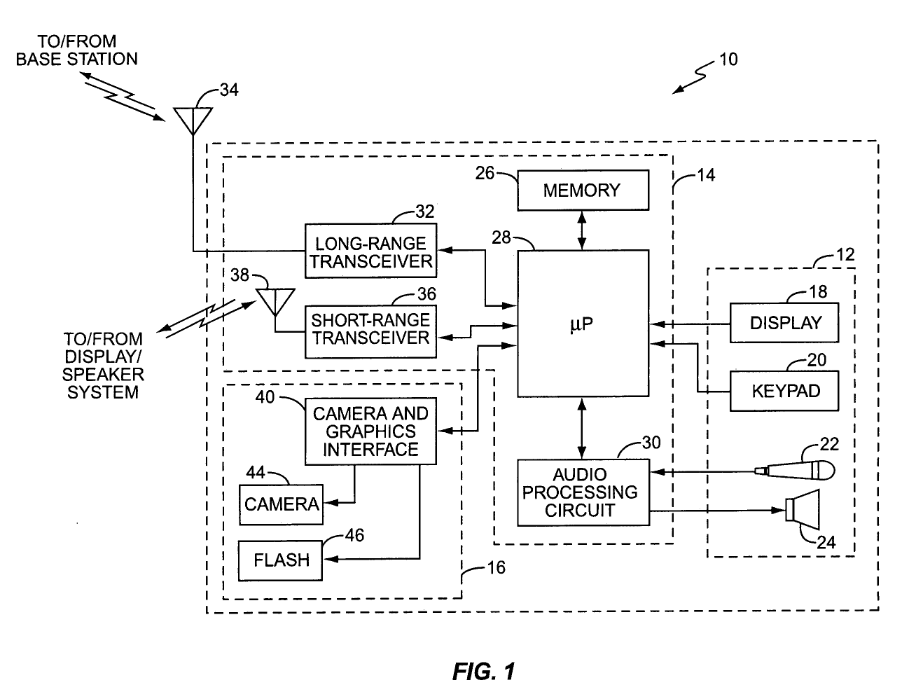

Referring now to the drawings, FIG. 1 illustrates one embodiment of a camera-equipped wireless communications device 10 according to the present invention. The figures illustrate device 10 in terms of a camera-equipped cellular telephone. However, those skilled in the art will readily appreciate that the present invention is applicable to any consumer electronics device having multimedia capability including, but not limited to, Personal Digital Assistants (PDAs), Personal Communication Services (PCS) devices, satellite telephones, palm or laptop computers, camcorders, digital cameras, and the like.

As seen in FIG. 1, device 10 comprises a user interface 12, communications circuitry 14, and a camera assembly 16. User interface 12 includes a display 18, a keypad 20, a microphone 22, and a speaker 24. Display 18 and speaker 24 are examples of multimedia rendering devices internal to the wireless communication device 10. Display 18 permits users to view dialed digits, call status, menu options, and other service information. Display 18 also acts as a viewfinder that permits users to view images and video captured by camera assembly 16, as well as remote images and video captured and transmitted by one or more remote parties as part of a teleconference call. Keypad 20, disposed on a face of device 10, includes an alphanumeric keypad and other input controls such as a joystick, button controls, or dials (not shown). Keypad 20 allows the operator to dial numbers, enter commands, and select options from menu systems. Additionally, keypad 20 permits the user to control the functionality of camera assembly 16.

Microphone 22 and speaker 24 are communicatively coupled to controller 28 via audio processing circuit 30, and may be comprised of any type of audio transducer known in the art. Microphone 22 converts the user's speech into electrical audio signals for transmission to remote parties, while speaker 24 converts audio signals received from remote parties into audible sound that can be heard by the user.

Communications circuitry 14 comprises memory 26, a controller 28, an audio processing circuit 30, a long-range transceiver 32 having an antenna 34, and a short-range transceiver 36 having an antenna 38. Memory 26 represents the entire hierarchy of memory in device 10, and may include both random access memory (RAM) and read-only memory (ROM). Computer program instructions and data required for operation are stored in non-volatile memory, such as EPROM, EEPROM, and/or flash memory, and may be implemented as discrete devices, stacked devices, or integrated with controller 28.

Controller 28 is a microprocessor, for example, and controls the operation of device 10 according to programs stored in memory 26, and may use known techniques to digitally alter images and/or video captured by camera assembly 16. The control functions may be implemented in a single microprocessor, or in multiple microprocessors. Suitable controllers may include, for example, both general purpose and special purpose microprocessors and digital signal processors. Controller 28 may interface with audio processing circuit 30, which provides basic analog output signals to speaker 24 and receives analog audio inputs from microphone 22. Controller 28, as will be described in more detail below, may control the output of multimedia data, such as image, video, and audio data, based on the type of multimedia data and the availability and/or capabilities of one or more remote multimedia capable systems.

Long-range transceiver 32 receives signals from and transmits signals to one or more base stations in a wireless communications network. Long-range transceiver 32 is a fully functional cellular radio transceiver, and operates according to any known standard, including Global System for Mobile Communications (GSM), TIA/EIA-136, cdmaOne, cdma2000, UMTS, and Wideband CDMA. According to one embodiment of the present invention, signals related to a teleconference call with one or more remote parties are transmitted and received by long-range transceiver 32.

Short-range transceiver 36 transmits signals to and receives signals from one or more corresponding short-range transceivers, as will be described in more detail below. In one embodiment, short-range transceiver 36 is a BLUETOOTH transceiver or RF transceiver operating according to the IEEE 802.11(b) or 802.11(g) standards. As is well known in the art, BLUETOOTH is a universal radio interface that permits the creation of ad hoc networks, and is particularly well-suited for communications over short distances. It should be understood, however, that short-range transceiver 36 may utilize any technology known in the art operable to transmit and receive signals over short distances, such as infra-red, for example.

Camera assembly 16 includes a camera and graphics interface 40, a camera 44, and an optional integrated flash 46. Camera and graphics interface 40 interfaces camera 44 with controller 28 and/or user interface 12. Commands and data to and from camera 44 are typically processed by camera and graphics interface 40 as is known in the art. While the camera and graphics interface 40 is shown as a separate component in FIG. 1, it will be understood that camera and graphics interface 40 may be incorporated with controller 28.

Camera 44 may be any camera known in the art, and may include such elements as a lens assembly (not shown), an image sensor (not shown), and an image processor (not shown). Camera 44 captures images that can be digitized and stored in memory 26, digitally altered by controller 28, or output to display 18. Flash 46 emits a flash of light to illuminate, if required, the subject of the image being captured. As is known in the art, camera 44 may capture images and/or video for transmission over a wireless network via long-range transceiver 32, such as when the user is engaged in a teleconference call.

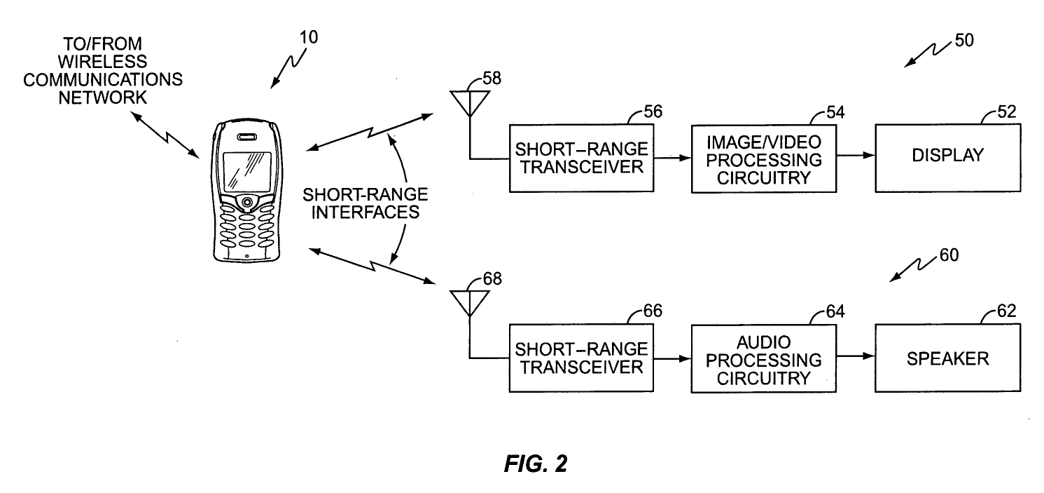

FIG. 2 illustrates one embodiment of the present invention wherein the user of wireless communications device 10 is participating in a teleconference call with one or more remote parties. According to the present invention, wireless communication device 10 provides the video images and associated audio signals transmitted by the one or more remote parties to external display device 50 and an external audio device 60.

External display device 50 comprises a display 52, image processing circuitry 54, and a short-range transceiver 56. It should be understood that display 52, image processing circuitry 54, and short-range transceiver might be a unitary device, or alternatively, a collection if interconnected components. Display 52 comprises one or more display screens that may be either fixed or mobile, and is coupled to the short-range transceiver 56 via image processing circuitry 54. Image signals received from device 10 via a short-range interface are displayed on display 52. Display 52 generally is able to display the received image signals at a higher resolution than the display 18 provided on wireless communication device 10. In one embodiment, display 52 is a video projection screen associated with a fixed video projection system of the type typically found in conference rooms or office environments. In another embodiment, display 52 is a display screen disposed on a computing device, such as a laptop or desktop computer. In still other embodiments, display 52 is a plasma screen or a user's home television set.

Image processing circuitry 54 comprises one or more processors (not shown), memory (not shown), and one or more devices configured decompress and render image and/or video signals as is known in the art prior to sending the image and or video signals to display 52. Image processing circuitry 54 may use any compression standard known in the art, such as MPEG 4, for example.

Short-range transceiver 56 is coupled to antenna 58, and is capable of detecting short-range transceiver 36 of wireless communication device 10 when device 10 comes within close geographical proximity to display 52. In one embodiment, short-range transceiver 56 detects short-range transceiver 36, and establishes an ad-hoc communications link according to well-known BLUETOOTH protocols. During the establishment of the communications link, various parameters, such as protocol version, capabilities, and device identities, may be negotiated between remote display system 50 and wireless communication device 10. In addition, synchronization and authentication of external display device 50 and/or wireless communication device 10 may occur according to well-known standards. Once the link is established, wireless communication device 10 may transmit image and/or video signals received from the wireless communications network to external display device 50.

External audio device 60 comprises one or more speakers 62, audio processing circuitry 64, and a short-range transceiver 66. Like the external display device 50, the components of external audio device 60 may or may not be structured as a unitary device. In addition, it is possible, but not required, that external display device 50 and external audio device 60 be a single system capable of outputting both the received image/video signals and audio signals received from wireless communications device 10.

Speaker 62 comprises one or more speakers, such as conic speakers, flat-panel speakers, or other known speakers, capable of rendering audio signals as audible sound to the user of wireless communication device 10. Audio signals associated with the image sent to external display device 50 are received from wireless communication device 10 via a short-range interface and rendered for the user through speaker 62. In one embodiment, speaker 62 is a sound system associated with external display device 50. In another embodiment, speaker 62 is a speaker associated with a computing device. Other embodiments contemplate speaker 62 as one or more speakers in a user's home stereo system.

Audio processing circuitry 64 receives an audio signal from wireless communication device 10 over a short-range interface, decompresses the signal, and outputs the decompressed signal to speaker 62 to produce audible sound. Short-range transceiver 66 includes an antenna 68, and is capable of the same sort of functionality as short-range transceiver 36 and 56. Like short-range transceivers 36 and 56, short-range transceiver 66 is operates according to well-known BLUETOOTH standards to detect other short-range transceivers, such as short-range transceiver 36, to create and maintain ad hoc networks. Once a communications link between short-range transceivers 36 and 66 is established, wireless communication device 10 may send audio associated with a teleconference call to speaker 62.

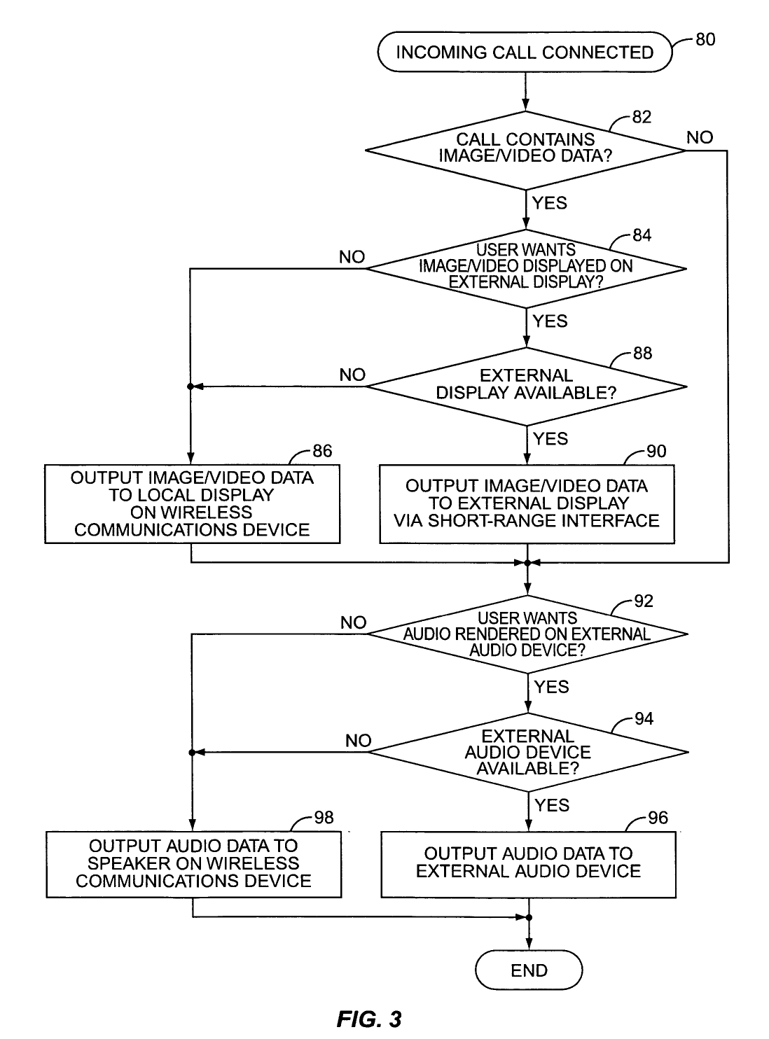

As previously stated, the present invention permits a user participating in a teleconference to output the image/video and audio signals to external display and/or audio devices 50, 60 rather than to the user's wireless communications device 10. This permits the user to view the image/video of the remote teleconference call participants and/or listen to the audio without the constraints necessarily inherent with device 10. FIG. 3 illustrates one method by which the present invention may occur.

The call flow of FIG. 3 begins when the user of wireless communication device 10 receives an incoming call (box 80) over a wireless communications network via long-range transceiver 32. Controller 28 examines the data in the received signals to determine whether the received signal contained image/video data (box 82). For example, the headers or control parts of many messages operating according to known standards contain indicators or flags that identify the type of data contained in the message as image or video data. In these cases, controller 28 would determine whether the incoming data is image/video data based on this indicator. In other cases, the image/video data might include one or more tags embedded in the data, and known to wireless communication device 10 a priori. Controller 28 of wireless communication device 10 would read the one or more tags as part of the data processing, and use the one or more tags to determine whether the data was image/video data. However, the present invention is not limited to any one method, as any method may be used to differentiate image/video data from other types of data, for example, audio data.

If the received signal did not contain image/video data, controller 28 would check to determine whether the received signal contained audio data (box 92). However, if the received signal contained image/video data, controller 28 would determine whether the user desired to output the image/video data to display 18 on wireless communications device 10, or display 52 of external display device 50 (box 84). This decision may be accomplished in any number of ways. In one embodiment, for example, the user selects between display 18 and display 52 by manually entering a destination ID for display 52 using keypad 20. In another embodiment, controller 28 reads a user-defined configuration profile from memory 26, and routes the image/video data based on the information in the profile. In other embodiments, controller 28 will automatically output all image/video data to display 52 if display 52 is available. Still other embodiments will output image/video data to both display 18 and display 52. Should the user opt not to output the signal to display 52, controller 28 will output the image/video data to display 18 on wireless communication device 10 (box 86). Otherwise, controller 28 will check the availability of display 52 (box 88). If display 52 is available, controller 28 will redirect the image/video data associated with the incoming call to the display 52 via the established short-range interface (box 90).

Those skilled in the art will appreciate that checking the availability of display 52 from device 10 may be accomplished through many known methods. One such method is by using the BLUETOOTH paging mechanism. The creation and maintenance of ad hoc networks is well known to those skilled in the art. Briefly, BLUTOOTH devices are able to detect the presence of other similarly enabled devices, and create ad hoc networks. The BLUETOOTH standards include a mechanism to negotiate and establish a communications channel with the detected devices, and to determine the capabilities of the detected devices. The detection of the devices, establishment of the communications channel, and capability negotiation may be done in advance of receiving the incoming call. In the present invention, the geographical area in which the short-range transceivers 36, 56 might detect each other roughly coincides with an area that the user might be able to view display 52.

Next, controller 28 will determine whether the user wishes to send the audio data associated with the image/video data to speaker 24 of wireless communication device 10, or speaker 62 of external audio device 60 (box 92). If the user does not want to hear the audio over speaker 52, controller 28 will direct the audio signals to speaker 24 of device 10 (box 98). Otherwise, controller 28 will determine whether external audio device 60 is available (box 94). Like the creation and establishment of the ad hoc network above, the BLUTOOTH paging mechanism may be used to create and maintain a communications link between short-range transceiver 36 and short-range transceiver 66. If external audio device 60 is available (box 94), controller 28 will re-direct the audio data to external audio device 60 (box 96), which will render the audio data as audible sound over speaker 62.

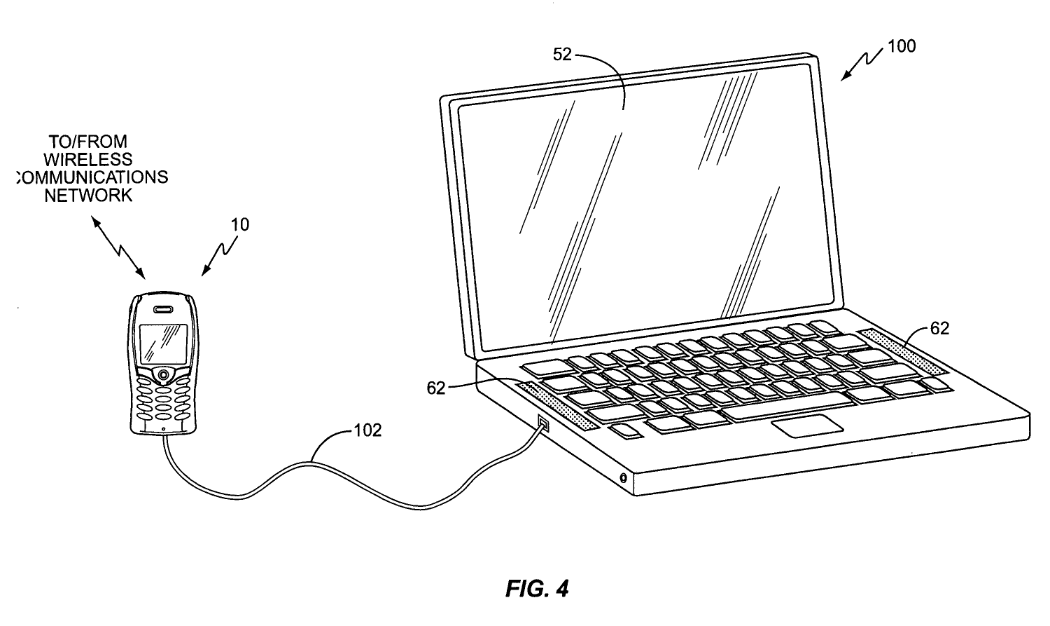

The previous embodiment illustrated how wireless communication device 10 might output the image/video and audio data associated with an incoming call to external display and audio devices 50, 60 using one or more established ad-hoc short-range interfaces. However, the present invention is not so limited. In an alternate embodiment, shown in FIG. 4, device 10 outputs the audio and image/video signals to a computing device 100 that is not equipped with a short-range transceiver. In this embodiment, both wireless communication device 10 and computing device 100 are FIREWIRE enabled, and connected via a FIREWIRE cable 102. As known in the art, FIREWIRE is a cross-platform implementation of a high-speed serial data bus, and permits the transfer of large amounts of audio and/or image data between devices at very high speeds. The FIREWIRE standards are defined by the IEEE 1394-1995, IEEE 1394a-2000, and IEEE 1394b standards, which are incorporated herein in their entirety.

In FIG. 4, device 10 receives the audio and image/video data associated with an incoming call from the wireless communications network. Controller 28 may be configured to translate the incoming data from whatever protocol they are received to a protocol compatible with the FIREWIRE standards. Controller 28 then transmits the audio and image/video data to computing device 100, which displays the images/video on display 52, and renders the audio through one or more speakers 62.

In addition to outputting audio and image/video data received from wireless communication device 10, computing device 100 may be used to upload multimedia data to wireless communication device 10 for later playback on remote display system 50, remote audio system 60, or another computing device 100. For example, users regularly create slide shows and other business articles as part of a job function. Once created, users must often transfer the completed multimedia files over a network to another system for presentation to other personnel, or manually carry the machine storing the files to a common meeting area. Using the present invention, however, a user who creates a business article having multimedia components, such as a slide show, simply transfers the files from computing device 100 to wireless communication device 10. Thereafter, wireless communication device 10 is used to output the multimedia data to external display device 50, external audio device 60, or another computing device 100.

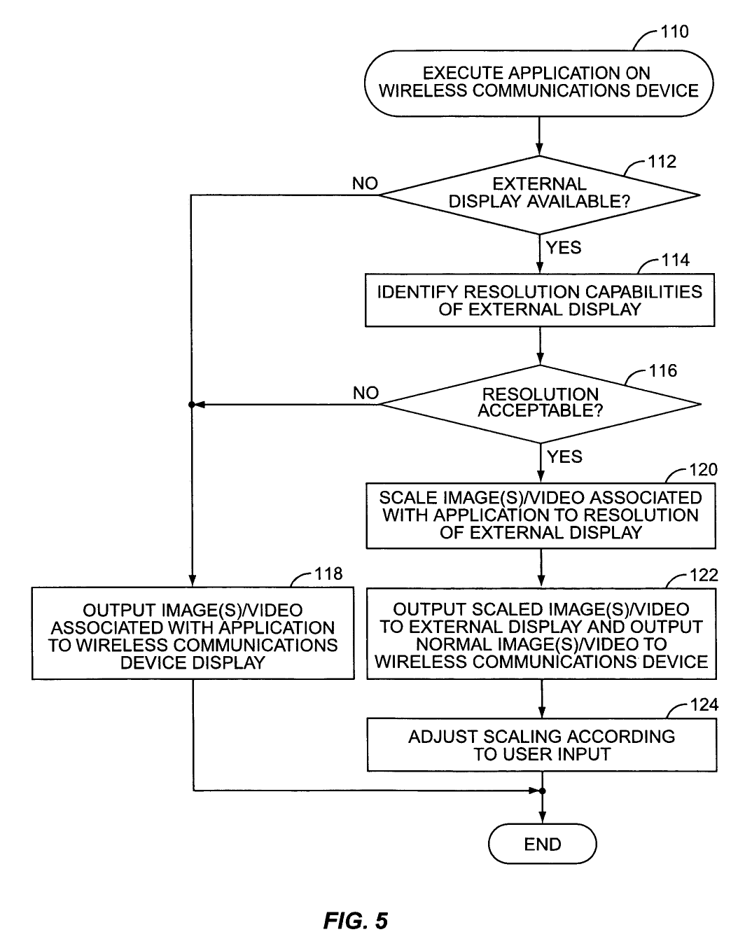

One illustration of this embodiment is shown in FIG. 5. In FIG. 5, the user has already created the multimedia data containing audio and image/video components on computing device 100, and downloaded the data to device 10. This may be accomplished using FIREWIRE as shown above, or alternatively, by wirelessly downloading the data via a short-range or long-range interface. In these latter two download methods, computing device 100 would be equipped with a short-range transceiver or a long-range transceiver, or both. Other methods of transferring the multimedia data may also be envisioned.

In FIG. 5, the user would execute an application stored on the wireless communications device 10 (box 110). Wireless communication device 10 would detect whether a display 52 was available, for example, via a short-range interface or FIREWIRE cable connection (box 112). If display 52 is not available or present, the user could simply view the output on display 18 (box 118) of wireless communication device 10. If display 52 was available, controller 28 would then identify the resolution of display 52 (box 114), and determine whether the resolution was acceptable to display the particular multimedia data (box 116). The resolution of display 52 could be determined during the establishment of the short-range interface, or alternatively, in response to a request from wireless communication device 10 once the communication link was established. If the resolution of display 52 is unacceptable, the user could simply view the image/video on display 18 of wireless communication device 10 (box 118). Otherwise, controller 28 would scale the video and or images to be displayed to the resolution of display 52 (box 120). Once scaled, controller 28 would transmit the image and/or video data for display on display 52 (box 122). The user could then use keypad 20, for example, to adjust the scaling or other properties of the displayed video or images (box 124).

It should be noted that the present application mentions the BLUETOOTH and FIREWIRE standards specifically as methods to effect transfer of the multimedia data to various remote systems. However, those skilled in the art will readily appreciate that other protocols and various adapters may be used in place of the mentioned protocols to perform the same functionality. For example, device 10 may transmit the multimedia data to one or more external multimedia rendering devices by direct wiring via USB ports, Audio/Video adapters, or other digital video and audio interfaces. In addition, wireless standards other than BLUETOOTH, such as infra-red, may be utilized to effect data transfer to and from wireless communication device 10. Further, controller 28 may be configured to send multimedia data to multiple displays 52 and/or speakers 62.

The present invention may, of course, be carried out in ways other than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A wireless communications device comprising:
a long-range transceiver to transmit multimedia data to and receive multimedia data from a wireless communications network;
a short-range transceiver to transmit the multimedia data to an external short-range transceiver disposed in an external multimedia rendering device;
a controller to detect the capabilities of external multimedia rendering device and to establish a first short-range interface between the short-range transceiver and the external short-range transceiver; and
wherein the controller is configured to re-direct the received multimedia data received to the external multimedia rendering device via the first short-range interface.

2. The device of claim 1 wherein the multimedia data received from the wireless communications network includes image data.

3. The device of claim 2 wherein the short-range transceiver transmits the image data to the external short-range transceiver for display on a display.

4. The device of claim 1 wherein the multimedia data received from the wireless communications network includes audio data.

5. The device of claim 4 wherein the short-range transceiver transmits the audio data to the external short-range transceiver for rendering as audible sound on a speaker.

6. The device of claim 1 wherein the multimedia data received from the wireless communications network comprises audio data and image data associated with an on-going call.

7. The device of claim 6 wherein the on-going call is a teleconference call between a user of the wireless communications device and one or more remote parties.

8. The device of claim 6 wherein the controller is configured to distinguish between the audio data and the image data received by the long-range transceiver from the wireless communications network.

9. The device of claim 6 wherein the external multimedia rendering device comprises a external display device, and wherein the controller is configured to establish a second short-range interface with an external short-range transceiver disposed in a external audio device.

10. The device of claim 7 wherein the controller re-directs the image data to the external display device via the first short-range interface, and the audio data to the external audio device via the second short-range interface.

11. The device of claim 1 wherein the controller is configured to re-direct the multimedia data received from the wireless communications network to the external multimedia rendering device responsive to user input.

12. The device of claim 1 wherein the controller is configured to re-direct the multimedia data received from the wireless communications network to the external multimedia rendering device responsive to information contained in a pre-configured user profile.

13. The device of claim 1 wherein the remote multimedia system comprises a computing device having a display and a speaker.

14. The device of claim 13 wherein the first short-range interface comprises cabling that interconnects the short-range transceiver on the wireless communications device and the external short-range transceiver on the computing device.

15. The device of claim 14 wherein the multimedia data received by the long-range transceiver include audio data and image data, and wherein the controller re-directs the image data to the computing device for display on the display, and re-directs the audio data to the computing device for rendering over the speaker.

16. The device of claim 13 wherein the controller is configured to store audio data and image data downloaded from the computing device.

17. The device of claim 16 wherein the controller is configured to re-direct the audio data and the image data downloaded from the computing device to a display and a speaker via one or more short-range interfaces.

18. A method of re-directing multimedia data received by a wireless communications device to an external multimedia rendering device, the method comprising:
establishing a first short-range interface between a wireless communications device and a detected external multimedia rendering device;
receiving, at the wireless communications device, multimedia data transmitted by one or more remote parties via a wireless communications network; and
re-directing the received multimedia data to the external multimedia rendering device via the first short-range interface if a suitable external multimedia rendering device is available.

19. The method of claim 18 wherein establishing a first short-range interface further comprises establishing an ad-hoc network between the wireless communications device and the external multimedia rendering device.

20. The method of claim 18 wherein establishing a first short-range interface comprises interconnecting the wireless communications device and the external multimedia rendering device via cabling.

21. The method of claim 18 wherein the multimedia data received from the remote parties includes image data.

22. The method of claim 21 further comprising identifying the resolution of a display disposed in the external multimedia rendering device.

23. The method of claim 22 further comprising scaling the image data received from the remote parties to the resolution of the display in the external multimedia rendering device, and re-directing the scaled image to the external multimedia rendering device via the first short range interface.

24. The method of claim 23 further comprising adjusting the resolution of the image data being displayed on the display in the external multimedia rendering device.

25. The method of claim 18 wherein the multimedia data received from the remote parties includes audio data.

26. The method of claim 25 wherein re-directing the multimedia data comprises re-directing the audio data to the external multimedia rendering device for rendering on a speaker.

27. The method of claim 18 wherein the multimedia data comprises audio data and image data associated with an incoming call.

28. The method of claim 27 wherein the incoming call is a teleconference call.

29. The method of claim 27 further comprising establishing a second short-range interface with a second external multimedia rendering device.

30. The method of claim 29 further comprising distinguishing, at the wireless communications device, between the audio data and the image data received from the remote parties.

31. The method of claim 30 wherein re-directing the multimedia data to the external multimedia rendering device via the first short-range interface comprises transmitting the image data to a remote display in the external multimedia rendering device.

32. The device of claim 31 further comprising re-directing the audio data to a remote speaker disposed in the second external multimedia rendering device.

33. The method of claim 18 further comprising uploading multimedia data from the external multimedia rendering device, and storing the uploaded multimedia data in memory on the wireless communications device.

34. A system for rendering multimedia data received by a wireless communications device on an external multimedia rendering device, the system comprising:
a wireless communications device comprising a display and a speaker, and configured to receive image data and audio data from one or more remote parties via a wireless communications network;
an external display device to display the image data received by the wireless communications device;
an external audio device to render the audio data received by the wireless communications device as audible sound; and
a controller in the wireless communications device to re-direct the received image data from the display to the external display device, and the received audio data from the speaker to the external audio device.

35. The system of claim 34 wherein the controller is configured to establish a short-range interface between a short-range transceiver in the wireless communications device and a corresponding short-range transceiver associated with the external display device.

36. The system of claim 34 wherein the controller is configured to establish a short-range interface between a short-range transceiver in the wireless communications device and a corresponding short-range transceiver associated with the external audio device.

37. The system of claim 34 wherein the image data and the audio data are associated with an on-going teleconference call.

38. The system of claim 34 wherein the external audio device and the external display device comprise a computing device.
